(19) United States
(12) Patent Application Publication
(10) Pub. No.: US 2010/0328456 A1
(43) Pub. Date: Dec. 30, 2010

(54) Lenslet camera parallax correction using distance information

(75) Inventor: Juha H. Alakarhu, Helsinki (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/459,368

(22) Filed: Jun. 30, 2009

(51) Int. Cl. H04N 7/18

(52) U.S. Cl. 348/139; 348/E07.085

(57) ABSTRACT

An apparatus, method and software construct an image of a scene by determining distance information to an object in a scene; and using the distance information to correct parallax error when combining at least two images of the object which were captured from different viewpoints. A single image of the scene from the combining is then output, with the object corrected for parallax error. In one embodiment the distance information is input from an autofocus mechanism of a multi-camera imaging system, and in another the distance information is derived from one of an object recognition algorithm or a scene analysis algorithm. The two (or more) images that are combined are captured preferably on different lenslet cameras of the same multi-camera imaging system, each of which sees the object in the scene from a different viewpoint.

### TECHNICAL FIELD

The exemplary and non-limiting embodiments of this invention relate generally to digital imaging devices having two or more camera systems (such as different image sensor arrays) with different viewpoint positions which can give rise to parallax errors during image capture.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Digital imaging systems include complementary metal-oxide semiconductor CMOS devices which use an array of pixels whose outputs are read out by an integrated circuit (often made together with the pixel array on one semiconductor device, termed an image sensor). Each pixel contains a photodetector and possibly an amplifier. Another digital imaging technology uses charge coupled device CCD which is an array of diodes, typically embodied as p-n junctions on a semiconductor chip. Analog signals at these diodes are integrated at capacitors and the signal is also processed by a read-out circuit, and the capacitor arrangements may be within the readout circuit.

Whether digital systems such as the two types above or photographic film-type systems such as a dual lens reflex camera, there is a parallax problem inherent in any imaging system which captures the image simultaneously from two or more different viewpoints. This is a particularly difficult problem in lenslet cameras, which use an array of micro-lenses or which each corresponds to one (or more) pixels or diodes of the array that captures and digitally stores the image. The parallax problem also exists in viewfinder-type cameras whether digital or photographic film-based, in which the rangefinder views the scene from a different perspective from the lens which actually captures the image.

FIG. 1 is an exaggerated illustration of the parallax problem. There are two ‘cameras’ in the imaging system, which may be considered as individual arrays of pixels or individual lenses of a dual lens reflex film-type camera. For simplicity each camera is considered in the ideal to be viewing the scene from a single point, centered at the vertex of the illustrated fields of view. From its viewpoint, camera 1 sees in the near field an object in front of a more distant background. Due to the location of camera 1, the object obscures letter “G” of the background from camera 1 because the object is centered at about +15 degrees from the camera 1 optical axis. At the same time, from the viewpoint of camera 2 the same object obscures letter “C” of the background because that object is centered at about −15 degrees from the camera 2 optical axis. To combine these two images captured by camera 1 and camera 2 into a single image with higher resolution than either camera 1 or camera 2 alone could produce, as is typical for multi-array digital imaging systems, the near field object is blurred because it is seen differently by camera 1 and camera 2. In the dual lens reflex camera, the exposure on the photographic film simultaneously from both lenses causes the same result. The parallax problem is inherent because each ‘camera’ sees a slightly different image. For digital imaging sometimes the different arrays each capture a different color, in which case the parallax error manifests itself as color error as well as blur around the edges of the object.

The parallax problem diminishes with object distance from the camera lens. The angular difference between how the two cameras of FIG. 1 see that same object diminishes as the object is moved further from the cameras. One can readily imagine that at infinity each camera sees the object along their respective optical axes (which remain parallel as illustrated), in which case there is no parallax problem and no edge blurring or color error.

What is needed in the art is a way to correct color and edge distortions in digital photography that arise from the parallax problem, particularly in lenslet imaging devices.

### SUMMARY

The foregoing and other problems are overcome, and other advantages are realized, by the use of the exemplary embodiments of this invention.

In a first exemplary and non-limiting aspect of this invention there is a method that comprises determining distance information to an object in a scene; using the distance information to correct parallax error when combining at least two images of the object which were captured from different viewpoints; and outputting a single image of the scene from the combining, with the object corrected for parallax error.

In a second exemplary and non-limiting aspect of this invention there is an apparatus comprising: a sensor or a memory storing an algorithm for determining distance information to an object in a scene; at least two image capture devices, each configured to capture an image from a viewpoint different than any other of the at least two image capture devices; and a processor configured to use the distance information to correct parallax error when combining at least two images of the object which were captured by the at least two image capture devices.

In a third exemplary and non-limiting aspect of this invention there is an apparatus comprising: distance measuring means (such as for example a sensor or a stored algorithm) for determining distance to an object in a scene; multiple image capturing means (e.g., at least two image capture devices) each for capturing an image from a viewpoint different than any others of the multiple image capturing means; and error correction means (e.g., a processor) for using the distance information to correct parallax error when combining images of the object which were captured by the respective multiple image capturing means.

In a fourth exemplary and non-limiting aspect of this invention there is a computer readable memory storing a program of instructions that when executed by a processor result in actions. In this embodiment the actions comprise: determining distance information to an object in a scene; using the distance information to correct parallax error when combining at least two images of the object which were captured from different viewpoints; and outputting a single image of the scene from the combining, with the object corrected for parallax error.

### BRIEF DESCRIPTION OF THE DRAWINGS

FIG. 1 is a conceptual illustration of the parallax problem in which two cameras of an imaging system see the same near field object at different positions relative to a far field background.

FIG. 2 is a high level schematic diagram showing arrangement of read-out circuit, pixels and lenslets of a single camera with respect to a scene being imaged.

FIG. 3 is a schematic diagram illustrating four different cameras each sensitive to a particular color in the visible spectrum.

FIG. 4 is a schematic diagram of a multi-camera imaging system using autofocus distance information to correct for parallax error according to an embodiment of the invention.

FIG. 5 is a schematic diagram of a multi-camera imaging system using distance derived from object recognition information to correct for parallax error according to an embodiment of the invention.

FIG. 5 is a schematic diagram of a pixel array relative to a scene being imaged according to an example embodiment of the invention.

FIG. 6 shows a particularized block diagram of a user equipment embodying a multi-camera imaging system with multiple pixel and lenslet arrays and also having parallax error correction software stored in a memory, according to an embodiment of the invention.

FIG. 7 is a logic flow diagram that illustrates the operation of a method, and a result of execution of computer program instructions embodied on a computer readable memory, in accordance with the exemplary embodiments of this invention.

### DETAILED DESCRIPTION

As was noted above, the parallax error dissipates to near zero at large distances, and is most pronounced at shorter focal lengths between the lens and the near field object. This makes solving the problem a bit more complex since the extent of parallax error in the photographic arts varies from picture to picture. According to an example embodiment of the invention, distance information of the object from the camera is used to correct for parallax error in a multi-camera digital imaging system.

As will be detailed, this distance information may be directly measured, such as by an autofocus mechanism (e.g., rangefinder) which is already in common use on many cameras. In another embodiment the distance information is derived from scene recognition software/algorithm. A scene recognition algorithm determines which object or objects in a scene are most likely the objects of interest to the viewer, and focuses the lens or lenslets to sharpen the edges of that object or objects. From this focusing the distance to that object or object can also be computed, even though the camera system may have no way to directly measurement distance such as a rangefinder of earlier generation digital cameras.

In this manner embodiments of the invention can be readily incorporated into exiting camera designs via implementing software (e.g., a parallax error correcting algorithm) which uses the autofocus mechanism or other means like information readily extractable from the scene recognition software to determine the distance to the object and correct the parallax error.

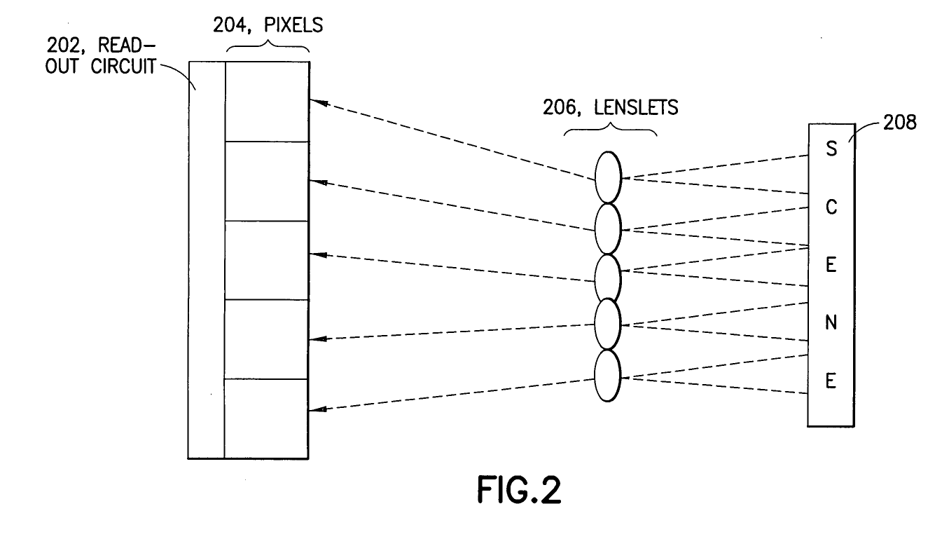

FIG. 2 illustrates in schematic form a sectional view of a single camera of which a multi-camera imaging system may use two, three or more to obtain a high resolution picture by integrating the image captured by each of them individually. While in the remaining Figures the camera is described as having a pixel array, the pixel embodiment is relevant to a CMOS implementation and other embodiments may instead be a CCD implementation using an array of diodes instead. The camera includes a read-out circuit 202, one row of an array of pixels 204 (e.g., photodetectors) and a corresponding row of an array of lenslets 206. The lenslets define the system aperture, and focus light from the scene 208 being imaged to the surface of the photoconducting pixels 204. [There is no near-filed object at FIG. 2 because it is not relevant for illustrating the components of the single camera shown there.] Typically the array of pixels 204 and the array of lenslets 206 are rectilinear, each being arranged in rows and columns. FIG. 2 illustrates one lenslet 206 corresponding to one pixel 204 but in some embodiments one lenslet may correspond to more than one pixel. The array of image sensing nodes 204 and/or the array of lenslets 206 may be planar as shown or curved to account for optical effects other than parallax.

FIG. 3 shows an example embodiment of an imaging system in which there are four parallel cameras 302, 304, 306, 308 which image red, blue and green from the target scene. Each of these cameras are, in one particular but non-limiting embodiment, arranged generally as shown at FIG. 2 so that each of them have an array of lenslets and an array of pixels. In some embodiments there may be a single read-out circuit on which each of the four pixel arrays are disposed (e.g., a common CMOS substrate), or each of the pixel arrays may have its own read-out circuit and the four cameras are each stand-alone imaging systems whose individual outputs are combined and integrated via software such as a super resolution algorithm. The super resolution algorithm integrates the individual images captured at the individual cameras and outputs the resulting single high resolution image (higher than any of the cameras individually could obtain) to a computer readable memory and/or to a graphical display for viewing by a user.

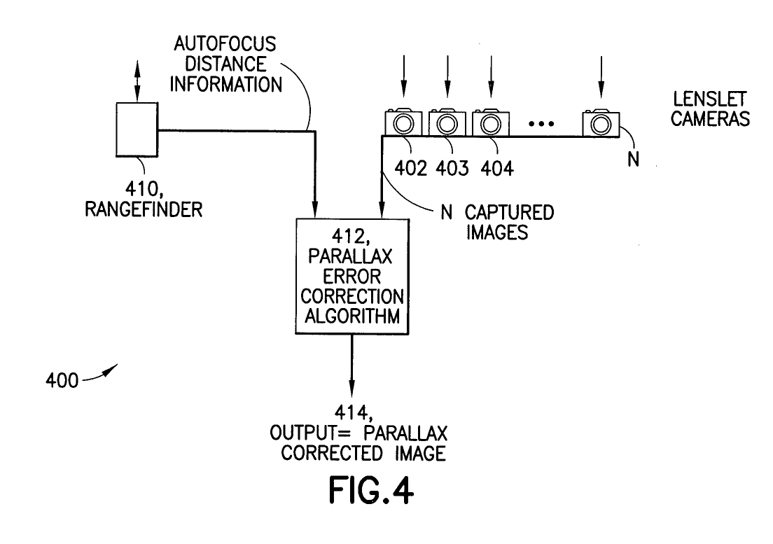

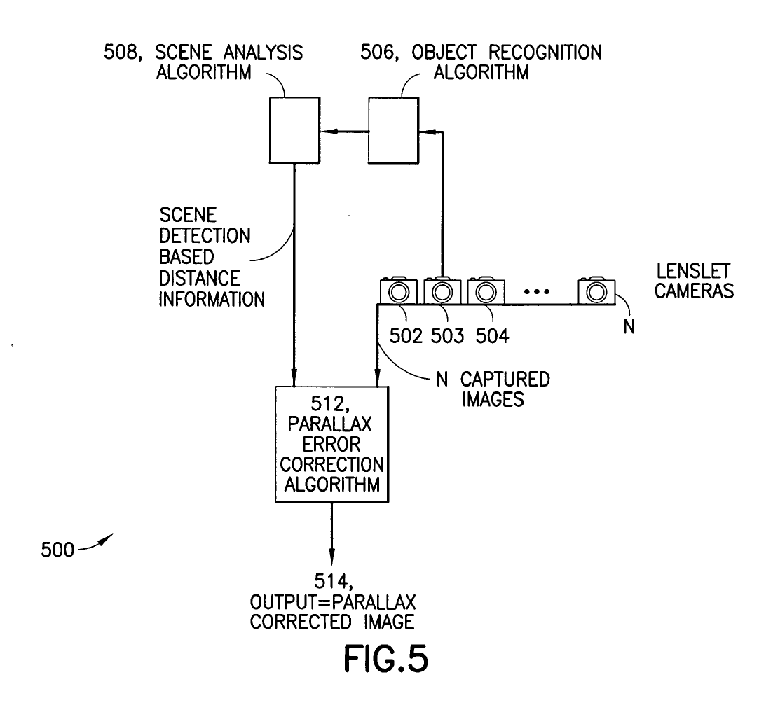

FIG. 4 schematically illustrates an embodiment of the invention in which distance information from an autofocus mechanism of the multi-camera imaging system 400 is used to correct for parallax when combining images from the multi-cameras. FIG. 4 illustrates a plurality of N cameras 402, 403, 404, . . . N, each as generally shown at FIG. 2 in a non-limiting embodiment. Also in a non-limiting embodiment the various cameras are color specific as shown at FIG. 3. N is clearly an integer greater than one. Each camera received light from a scene external of the system 400 and captures an image of the scene (which by the FIG. 4 illustration lies along the top of the page). There are then N images, each captured by an nth one of the cameras.

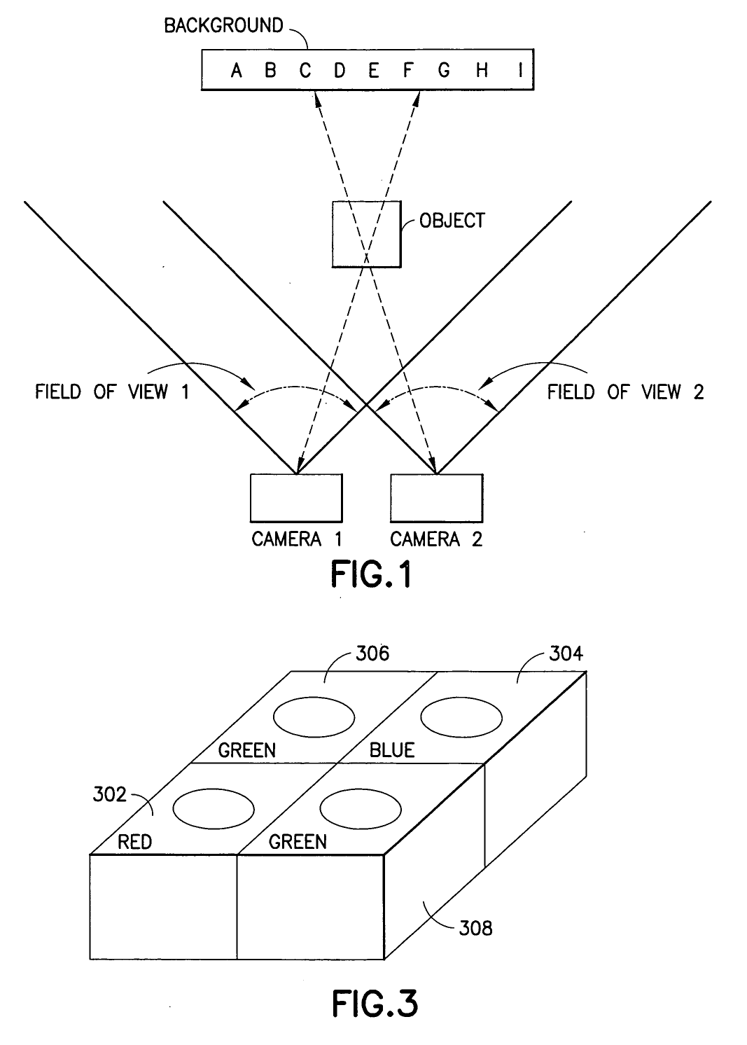

The system 400 also has an auto-focus mechanism, shown at FIG. 4 as a rangefinder 410 which is a non-limiting embodiment. The rangefinder measures distance to an object within the scene. In this instance the object is the near-field object, such as the one shown by example at FIG. 1, which is the cause of potential parallax error by the N cameras due to its position near enough to the cameras yet still distant enough from a far background (or infinity if for example the scene is a landscape) of the scene being captured. In an embodiment the rangefinder also provides distance information to the far background as well as to the near field object or object which cause the potential for parallax error. This is generalized at FIG. 4 as autofocus distance information.

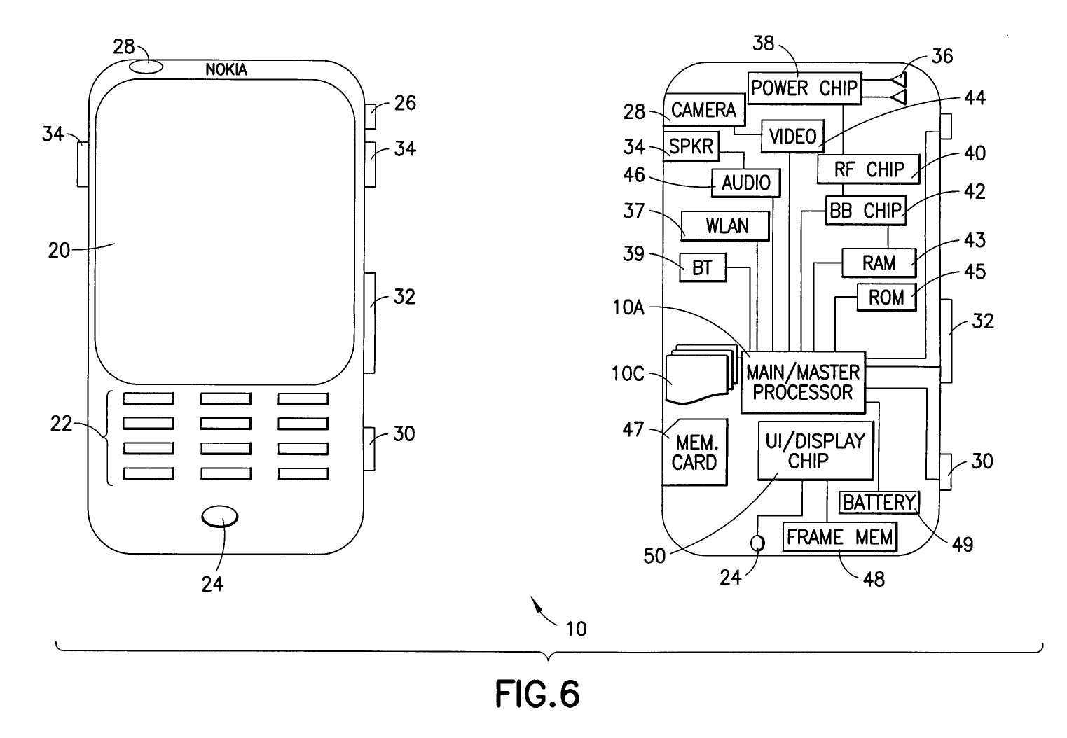

The N images are input to or otherwise operated on by a parallax error correcting algorithm 412, which uses the autofocus distance information to determine position of the object in the fields of view of the various N cameras (the N images from the cameras) and corrects for parallax error using that distance information. In an embodiment the parallax error correcting algorithm is within the super resolution algorithm which integrates the N images into a single high resolution image for output. The end result is that the output 414 from the multi-camera imaging system 400 is a single image which is corrected for parallax error that is present in the N images themselves by means of the autofocus distance information. That output 414 is in one embodiment manifest at a graphical display interface of the system (shown at FIG. 6) and in another embodiment is stored in a memory of the system 400 or of a host device (shown also at FIG. 6). Either embodiment may manifest the output 414 at both the graphical display interface and the memory.

FIG. 4 illustrates the autofocus mechanism 410 as separate and distinct from any of the N cameras for clarity of illustration, but in an embodiment the autofocus mechanism may be a component of any one or multiple ones of the N cameras. Because the camera user focuses to the most important part of the image which would be the near field object or objects that is the cause of potential parallax error, the parallax correction algorithm automatically knows what is the most critical distance to correct. The autofocus mechanism may in an embodiment measure distance through the lenslet array of an nth camera, or may measure distance without passing through the lens itself.

FIG. 5 schematically illustrates an embodiment of the invention in which distance information is obtained from an object recognition algorithm 506, which detects known objects such as faces, phones, hands, chairs, etc. It is known that object recognition software utilizes known absolute sizes of these objects that it recognizes and compiles an object distance information map using the relative sizes of the objects that appear in the scene being imaged. The program/algorithm 506 sharpens the image by focusing based on the distance at which it determines the object to be, given the relative object size in the scene as compared to the absolute object sizes that are known.

It is also known to enhance this object recognition algorithm with a scene analysis algorithm 508. This program 508 becomes operative if the scene being imaged is complicated and there are several recognized objects any of which might be the intended focus of the user. The scene analysis algorithm 508 determines which object or objects are the likeliest subjects that are the intent of the user to capture, and selects those objects as a basis for setting the focal length of the lens or lenslet arrays. One example of scene analysis algorithm 508 is where the scene has multiple faces at different focal distances from the lens; the scene analysis algorithm might select one or a cluster of faces near the center of the scene as the object at which to set the focal length.

Whether the system 500 of FIG. 5 has only an object recognition algorithm 506 or additionally a scene analysis algorithm 508, the distance from the camera (one or more of them) to the near field object which is the cause of potential parallax error is present within this scene detection based distance information which is input to the parallax error correction algorithm 512.

Similar to FIG. 4, the multi-camera imaging system 500 has a plurality of N cameras 502, 503, 504, . . . N, which each capture an image of the scene so that N images are input to or otherwise operated on by the parallax error correcting algorithm 512. For the embodiment of FIG. 5, it is the scene detection based distance information which is used to determine position of the object in the fields of view of the various N cameras (the N images from the cameras) and thereby correct for parallax error using that distance information. As with FIG. 4, the parallax error correcting algorithm 512 of the system 500 of FIG. 5 is, in a non-limiting embodiment, within the super resolution algorithm which integrates the N images into a single high resolution image for output.

The end result is that the output 514 from the multi-camera imaging system 500 is a single image which is corrected for parallax error that is present in the N images themselves by means of the scene detection based distance information. That output 514 is in one embodiment manifest at a graphical display interface of the system (shown at FIG. 6) and in another embodiment is stored in a memory of the system 500 or of a host device (shown also at FIG. 6). Either embodiment may manifest the output 514 at both the graphical display interface and the memory.

In one particular and non-limiting embodiment, the parallax correction algorithm 412, 512 operates by shifting each of the N individual camera images (e.g., the sub-images) so that image of each camera is aligned in the target distance. The shift amount depends on the distance information provided as an input to the parallax error correction algorithm 412, 512 as detailed by non-limiting example above at FIGS. 4-5.

In a particular embodiment in which the cameras are CMOS based technology, it is noted that the lenslet embodiments of the camera enable a much thinner camera and typically also an improved low light performance (by avoiding color crosstalk in embodiments with color-specific cameras) as compared to other digital imaging technologies currently known to the inventor. A technical effect of certain embodiments of this invention as presented above by example is a significantly improved image quality for such a lenslet camera system of the critical distance by avoiding parallax error which would manifest itself as ‘rainbow’ effects in the near-field object.

There are numerous host devices in which embodiments of the invention can be implemented. One example host imaging system is disposed within a mobile terminal/user equipment UE, shown in a non-limiting embodiment at FIG. 6. The UE 10 includes a controller, such as a computer or a data processor (DP) 10A, a computer-readable storage medium embodied as a memory that stores a program of computer instructions 10C, and one or more radio frequency (RF) transceivers for bidirectional wireless communications with other radio terminals and/or network nodes via one or more antennas.

At least one of the programs 10C is assumed to include program instructions that, when executed by the associated DP 10A, enable the apparatus 10 to operate in accordance with the exemplary embodiments of this invention, as detailed above by example. One such program 10C is the parallax error correction algorithm (which may or may not be one with the super resolution algorithm) which corrects for parallax error using object distance information as detailed by example above. That is, the exemplary embodiments of this invention may be implemented at least in part by computer software executable by the DP 10A of the UE 10, or by a combination of software and hardware (and firmware).

In general, the various embodiments of the UE 10 can include, but are not limited to, cellular telephones, personal digital assistants (PDAs) or gaming devices having digital imaging capabilities, portable computers having digital imaging capabilities, image capture devices such as digital cameras, music storage and playback appliances having digital imaging capabilities, as well as portable units or terminals that incorporate combinations of such functions. Representative host devices need not have the capability, as mobile terminals do, of communicating with other electronic devices, either wirelessly or otherwise.

The computer readable memories as will be detailed below may be of any type suitable to the local technical environment and may be implemented using any suitable data storage technology, such as semiconductor based memory devices, flash memory, magnetic memory devices and systems, optical memory devices and systems, fixed memory and removable memory. The DP 10A may be of any type suitable to the local technical environment, and may include one or more of general purpose computers, special purpose computers, application specific integrated circuits, read-out integrated circuits, microprocessors, digital signal processors (DSPs) and processors based on a dual/multicore processor architecture, as non-limiting examples.

FIG. 6 details an exemplary UE 10 host device in both plan view (left) and sectional view (right), and the invention may be embodied in one or some combination of those more function-specific components. At FIG. 6 the UE 10 has a graphical display interface 20 and a user interface 22 illustrated as a keypad but understood as also encompassing touch-screen technology at the graphical display interface 20 and voice-recognition technology received at the microphone 24. The output 414, 514 from the parallax error correction algorithm 412, 512 may be displayed at the interface 20 and/or stored in a computer readable memory (after further processing by the super resolution software in some embodiments). A power actuator 26 controls the device being turned on and off by the user. The exemplary UE 10 includes a multi-camera imaging system 28 which is shown as being forward facing (e.g., for video calls) but may alternatively or additionally be rearward facing (e.g., for capturing images and video for local storage). The multi-camera imaging system/camera 28 is controlled by a shutter actuator 30 and optionally by a zoom actuator 32 which may alternatively function as a volume adjustment for speaker(s) 34 when the imaging system 28 is not in an active mode. As above, within the imaging system 28 are a plurality of N individual cameras (each with a pixel or diode array and at least one array of lenslets for the system).

Within the sectional view of FIG. 6 there are multiple transmit/receive antennas 36 that are typically used for cellular communication. The antennas 36 maybe multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the imaging system 28 pass through an image/video processor 44 which encodes and decodes the various image frames. The read-out circuitry is in one embodiment one with the image sensing nodes and in another embodiment is within the image/video processor 44. In an embodiment the image/video processor executes the parallax error correction algorithm. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Also shown for completeness are secondary radios such as a wireless local area network radio WLAN 37 and a Bluetooth® radio 39. Throughout the apparatus are various memories such as random access memory RAM 43, read only memory ROM 45, and in some embodiments removable memory such as the illustrated memory card 47 on which the various programs 10C are stored. The parallax error correction algorithm/program may be stored on any of these individually, or in an embodiment is stored partially across several memories. All of these components within the UE 10 are normally powered by a portable power supply such as a battery 49.

The aforesaid processors 38, 40, 42, 44, 46, 50, if embodied as separate entities in a UE 10, may operate in a slave relationship to the main processor 10A, which then is in a master relationship to them. Any or all of these various processors of FIG. 6 access one or more of the various memories, which may be on-chip with the processor or separate therefrom. Note that the various chips (e.g., 38, 40, 42, 44 etc.) that were described above may be combined into a fewer number than described and, in a most compact case, may all be embodied physically within a single chip.

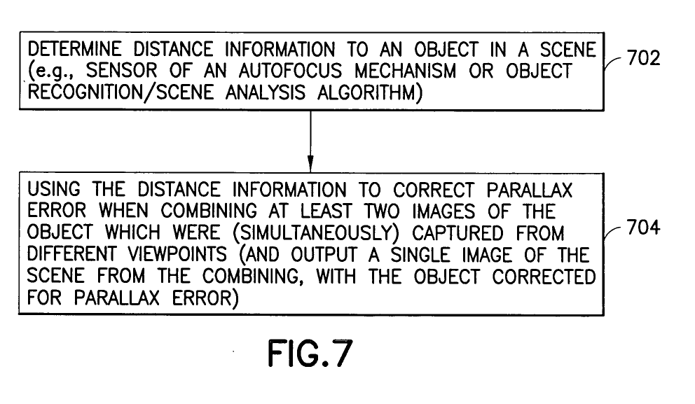

FIG. 7 is a logic flow diagram that illustrates the operation of a method, and a result of execution of computer program instructions, in accordance with the exemplary embodiments of this invention. In accordance with these exemplary embodiments a method performs, at block 702, a step of determining distance information to an object in a scene. As detailed above, in one embodiment the distance information is input from a sensor such as a rangefinder or some other autofocus mechanism of a multi-camera imaging system; and in another embodiment the distance information is derived from one of an object recognition algorithm or a scene analysis algorithm (e.g., from the distance information map that the object recognition algorithm generates).

Further at block 704 there is the step of using the distance information to correct parallax error when combining at least two images of the object which were (simultaneously) captured from different viewpoints. What is eventually output is a single image of the scene from the combining, with the object corrected for parallax error. The output can be to a graphical display interface and/or to a computer readable memory.

For the case where the distance information is derived from or otherwise obtained from the object recognition algorithm, it is noted that object recognition algorithm operates by comparing the object in the scene to known objects, and then determines the relative size of the object in the scene from a known absolute size of a known matching object. The distance information is derived from the determined relative size, which is how the object recognition algorithm generates its distance map.

As noted above, the parallax error may be corrected by shifting at least one of the images of the object (and possibly all of them) so that each of the at least two images are aligned at a distance of the object from a multi-camera imaging system that executes the method. More generally, there are N cameras in the system which capture the image of the object from N different respective viewpoints. For the case where color-specific cameras are used, at least three of the N cameras are color specific and capture images in a color different from others of the at least three cameras, and correcting for parallax error includes correcting for parallax error in color combining at the object.

The various blocks shown in FIG. 7 and the more detailed implementations immediately above may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects maybe implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
determining distance information to an object in a scene;
using the distance information to correct parallax error when combining at least two images of the object which were captured from different viewpoints; and
outputting a single image of the scene from the combining, with the object corrected for parallax error.

2. The method according to claim 1, in which the distance information is input from an autofocus mechanism of a multi-camera imaging system.

3. The method according to claim 1, in which the distance information is derived from one of an object recognition algorithm or a scene analysis algorithm.

4. The method according to claim 3, in which the object recognition algorithm operates by comparing the object to known objects and determines the relative size of the object from a known absolute size of a known matching object, and the distance information is derived from the determined relative size.

5. The method according to claim 1, in which using the distance information to correct parallax error comprises shifting at least one of the images of the object so that each of the at least two images are aligned at a distance of the object from a multi-camera imaging system that executes the method.

6. The method according to claim 1, executed by a portable multi-camera imaging system having N cameras each of which captures an image of the object,
and in which the distance information is used to correct parallax error when combining N images of the object captured by the respective N cameras from respective N different viewpoints, wherein N is an integer at least equal to three.

7. The method according to claim 6, in which at least three of the N cameras are configured to capture images in a color different from others of the at least three cameras, and in which correcting for parallax error comprises correcting for parallax error in color combining at the object.

8. The method according to claim 1, executed by a user equipment that comprises a portable multi-camera imaging system, in which each of the at least two images of the object were captured by different lenslet cameras of the multi-camera imaging system.

9. An apparatus comprising:
a sensor or a memory storing an algorithm for determining distance information to an object in a scene;
at least two image capture devices, each configured to capture an image from a viewpoint different than any other of the at least two image capture devices; and
a processor configured to use the distance information to correct parallax error when combining at least two images of the object which were captured by the at least two image capture devices.

10. The apparatus according to claim 9, in which the distance information is determined by the sensor which comprises an autofocus mechanism.

11. The apparatus according to claim 9, in which the distance information is determined by the algorithm which comprises one of an object recognition algorithm or a scene analysis algorithm stored on a computer readable memory.

12. The apparatus according to claim 11, in which the object recognition algorithm is configured to operate by comparing the object to known objects stored in the memory and to determine the relative size of the object from a known absolute size of a known matching object, and the algorithm is configured to derive the distance information from the determined relative size.

13. The apparatus according to claim 9, in which the processor is configured to use the distance information to correct parallax error by shifting at least one of the captured images of the object so that each of the at least two captured images are aligned at a distance of the object from the apparatus.

14. The apparatus according to claim 9, in which each of the image capture devices comprise a camera and the apparatus comprises a portable multi-camera imaging system having N cameras each of which captures an image of the object,
and in which the processor is configured to use the distance information to correct parallax error when combining N images of the object captured by the respective N cameras from respective N different viewpoints, wherein N is an integer at least equal to three.

15. The apparatus according to claim 14, in which at least three of the N cameras are configured to capture images in a color different from others of the at least three cameras, and in which the processor is configured to correct for parallax error by correcting for parallax error in color combining at the object.

16. The apparatus according to claim 9, in which the apparatus comprises a multi-camera imaging system disposed in a portable user equipment, in which each of the at least two image capture devices comprise a different lenslet camera of the multi-camera imaging system.

17. A computer readable memory storing a program of instructions that when executed by a processor result in actions comprising:
determining distance information to an object in a scene;
using the distance information to correct parallax error when combining at least two images of the object which were captured from different viewpoints; and
outputting a single image of the scene from the combining, with the object corrected for parallax error.

18. The computer readable memory according to claim 17, in which the distance information is determined from an autofocus mechanism of a multi-camera imaging system.

19. The computer readable memory according to claim 17, in which the distance information is derived from one of an object recognition algorithm or a scene analysis algorithm.

20. The computer readable memory according to claim 17, in which using the distance information to correct parallax error comprises shifting at least one of the images of the object so that each of the at least two images are aligned at a distance of the object from a multi-camera imaging system at which the images were captured.
